(19) United States
(12) Patent Application Publication
(10) Pub. No.: US 2025/0249293 A1
(43) Pub. Date: Aug. 7, 2025

(54) BLOWER FILTER DEVICE AND BLOWER FILTER SYSTEM

(71) Applicant: Dräger Safety AG & Co. KGaA, Lübeck (DE)

(72) Inventors: Sandra DANKERT, Lübeck (DE); Timo TRALAU, Lübeck (DE); Sören KIRMSE, Lübeck (DE)

(21) Appl. No.: 19/039,851

(22) Filed: Jan. 29, 2025

(30) Foreign Application Priority Data
Feb. 2, 2024 (DE) 10 2024 102 972.2

(51) Int. Cl. A62B 7/10; A62B 9/00

(52) U.S. Cl. CPC A62B 7/10; A62B 9/00

(57) ABSTRACT

A blower filter device and a blower filter system include a housing. At least one display element and/or at least one control element is integrated into the housing without an opening in the housing. The housing has a gapless uninterrupted display element and/or control element surface area in front of or behind the at least one display element and/or the at least one control element.

### CROSS REFERENCE TO RELATED APPLICATIONS

This application claims the benefit of priority under 35 U.S.C. § 119 of German Application 10 2024 102 972.2, filed Feb. 2, 2024, the entire contents of which are incorporated herein by reference.

### TECHNICAL FIELD

The present invention relates to a blower filter device and a blower filter system.

### BACKGROUND

Blower filter devices (fan filter devices) are a type of respiratory protection device (respirator). Respiratory protective devices are divided according to their mode of operation into filtering devices (filtering, acting depending on the ambient atmosphere) and isolating devices (supplying breathing gas, acting independently of the ambient atmosphere) and are also differentiated according to their configuration and mode of operation (function).

The various types of equipment are specified in corresponding German or European standards. The naming of individual parts of respiratory protective devices is defined in DIN EN 134.

Filtering devices can be equipped with a blower to cause an ambient air flow through a filter unit towards a user. Filtering devices of this type are referred to as powered air-purifying respirators (also known as PAPRs). Powered air-purifying respirators generally have a low inhalation resistance and also have a particularly favorable microclimate in the breathing connection.

A blower filter device of this type is known from DE 10 2012 013 656 A1.

Filtering devices can also have no blower, in which case the user must generate an ambient air flow through a filter unit by exerting their own breathing. This type of filtering device is also known as an APR (Air-Purifying Respirator) and is not the subject of the present invention.

A blower filter device is suitable for accommodating a filter unit in order to filter the ambient air with regard to solid, liquid and/or gaseous pollutants and to supply the filtered ambient air to the user of the filter unit.

Blower filter devices form a blower filter system with a breathing connection, a filter unit and possibly other components.

A breathing connection provides a fluidic connection between the blower filter device and the user, through which the user can breathe the filtered ambient air. Examples of known breathing connections include a mouthpiece set, a quarter mask, a half mask, a full face mask, a respiratory protection hood, a respiratory protection helmet and a respiratory protection suit.

Furthermore, a line such as a hose (also known as a breathing hose) is often provided between the blower filter device and the breathing connection—as part of the breathing connection or separately from it—which indirectly connects the breathing connection to the blower filter device. Alternatively, the breathing connection and the blower filter device are connected to each other directly, i.e. without an additional line.

Blower filter devices must be reprocessed, i.e. at least cleaned, after use. For this purpose, it is necessary that the blower filter device can be reprocessed.

### SUMMARY

It is therefore an object of the present invention to provide a blower filter device and corresponding blower filter system which are particularly easy to reprocess.

These and other objects are attained by a blower filter device according to the invention and by a blower filter system according to the invention.

The claims, description and figures provide advantageous embodiments of the invention.

According to the invention, a blower filter device is provided comprising a housing, wherein at least one display element and/or at least one control element is integrated into the housing without an opening.

The invention is based on the concept that the reprocessability (cleanability) of the blower filter device can be improved if its at least one display element and/or its at least one control element is integrated into the housing without an opening (aperture/breakthrough), since in this way gaps and/or cavities that are disadvantageous for reprocessing can be avoided.

An opening is understood to be an opening in the housing, in or in front of or behind which a display element and/or a control element is arranged. In other words, the invention provides a gap-free housing surface in the area of the at least one display element and/or the at least one control element.

At least one element (i.e. display elements or control element) is understood to mean exactly one element or a plurality of elements.

The housing can be configured in one or more parts. For example, the blower filter device can have a plurality of modules which can be connected via corresponding interfaces, whereby each of the modules can have a housing which represents a housing element in relation to the entire housing of the blower filter device, so that the housing of the blower filter device can be obtained by connecting the modules and thus the housing elements.

The blower filter device can be configured to accommodate a filter unit via a corresponding interface. A filter unit is understood to be a component which can comprise one or more filters. The filter unit can be configured to (temporarily) remove predetermined pollutants from the ambient air that can be guided through it, wherein these pollutants can be liquid, solid and/or gaseous substances. A filter unit can, for example, be configured as a particle filter, gas filter, combination filter, in particular as an AX filter, SX filter and/or as a CO filter.

A filter unit can, for example, have a filter material (filter medium) or a plurality of filter materials (filer media), which can be surrounded by a filter housing that forms an air inlet on an upstream side of the filter unit and an air outlet on a downstream side of the filter unit. As part of the housing or separately therefrom, the filter unit may have a filter connection for connection to the blower filter device, i.e. a mechanical interface for coupling with the blower filter device.

A filter unit can have further and/or other components than those mentioned above.

The blower filter device can have a blower unit (also referred to simply as a blower), which can have a fan wheel (impeller) driven by an electric motor and a fan housing adapted to the fan wheel (e.g. a spiral housing). The drive energy for the blower unit and an associated control unit can be provided by an energy storage unit, which can preferably have rechargeable batteries (accumulators or secondary cells). The control unit can also be configured to process user inputs that can be entered via the at least one control element. These inputs can include, for example, switching the blower unit on and off or adjusting the power of the blower unit. In addition, the control unit can be configured to adapt the power of the motor (or blower unit) to the user's requirements. This is particularly important if the user requires more breathing air due to increased physical exertion or if the breathing resistance through the filter increases after a longer period of operation. The blower unit, the control unit and the energy storage unit are usually enclosed in the housing. The filter unit described above can be connected to the housing. Furthermore, the breathing tube or breathing connection described above can be connected directly to the housing. During operation, air is sucked through the filter unit into the housing of the blower unit by means of the blower unit and then directed (directly or indirectly) to the breathing connection.

Preferably, the at least one control element is configured to be operated by voice input and/or touch input and/or gesture input.

In this way, the operation of the blower filter device can be improved and operation can be simplified by the closed housing section in the area of the control element, i.e. an input area.

Preferably, the housing has a translucent area (translucent region), wherein the at least one display element is arranged to shine through the translucent area to effect a display.

In this way, the display can be simplified by the closed housing section in the area of the display element, i.e. the translucent area.

Preferably, the blower filter device also has an energy storage unit, whereby the energy storage unit is arranged entirely within the housing.

In the event that the blower filter device comprises several modules, it is preferred that the energy storage unit is completely accommodated in one of the modules, so that it is completely arranged within the housing by assembling the housing elements to form the housing.

This can also reduce the presence of gaps in relation to the energy storage unit.

Preferably, the blower filter device further comprises an energy interface for charging the energy storage unit, wherein the energy interface is arranged entirely within the housing.

In the event that the blower filter device comprises several modules, it is preferred that the energy interface is completely accommodated in one of the modules, so that it is arranged completely within the housing by assembling the housing elements to form the housing.

The energy interface can be, for example, an inductive interface, for example, which can be integrated into the housing without an opening, in particular without a gap.

Preferably, the blower filter device further comprises a mechanical interface for connection to a carrying structure (support structure) for carrying the blower filter device by a user, wherein the mechanical interface is configured as an interface extending away from the housing.

If a mechanical interface is provided, gaps and/or undercuts can hardly be avoided, but the reprocessability of the blower filter device can be improved in this way.

A suitable mechanical interface can, for example, be configured as a magnetic closure, as known from EP 3 652 399 A1 (EP 3 652 399 A1 is hereby incorporated by reference).

The carrying structure can be configured as a backpack/rucksack, hip belt and/or carrying strap, for example.

According to the invention, there is further provided a blower filter system, the blower filter system comprising a blower filter device as described above and a carrying structure for carrying the blower filter device by a user, wherein the blower filter device is fully integrated into the carrying structure.

These and other features and advantages of the invention are also apparent from the following description of the figures. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a perspective view showing an embodiment of a blower filter system and blower filter device according to the invention;

FIG. 2 is a schematic view showing an embodiment of a blower filter device according to the invention;

FIG. 3 is a schematic view showing an embodiment of a blower filter device according to the invention; and

FIG. 4 is a perspective view showing an embodiment of a blower filter system and blower filter device according to the invention.

### DESCRIPTION OF PREFERRED EMBODIMENTS

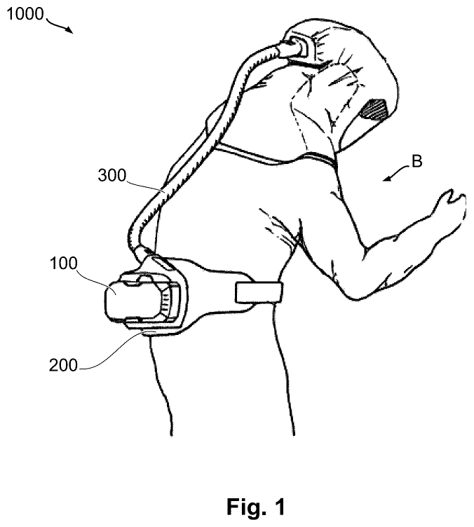

Referring to the drawings, FIG. 1 shows an embodiment of a blower filter system 1000 according to the invention with a blower filter device 100 according to the invention.

The blower filter system 1000 comprises a breathing connection 300, exemplarily shown as a breathing hood including a breathing tube, a blower filter device 100 according to the invention and a carrying structure 200 for carrying the blower filter device 100 by a user B.

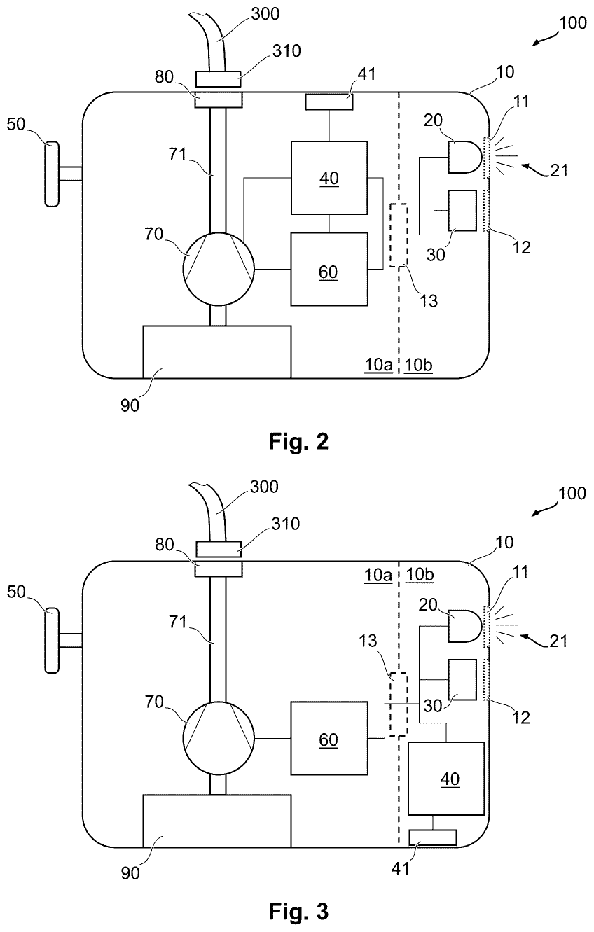

FIGS. 2 and 3 show two different embodiments of blower filter devices 100 according to the invention (hereinafter also collectively referred to as “the blower filter device 100”).

The blower filter device 100 has a housing (case) 10, wherein at least one display element 20 and/or at least one control element 30 is integrated into the housing 10 without an opening.

In the examples shown, this is implemented by the fact that the at least one display element 20 is arranged completely within the blower filter device 100 and the housing 10 has a translucent area 11, wherein the at least one display element 20 is arranged to shine through the translucent area 11 in order to effect a display. This is indicated by schematic rays 21.

In the example shown, the translucent area is integral with the housing 10 in order to be connected to the housing 10 without any gaps.

Furthermore, the at least one control element 30 is configured to be operated by voice input and/or touch input and/or gesture input. In the examples shown, this is implemented in that the at least one control element 30 is arranged completely within the blower filter device 100 and the housing 10 has an input area 12 through which the at least one control element 30 can detect the input.

In the embodiments shown, the blower filter device 100 can have a blower unit 70, which is fluidically connected via a line 71 upstream to a filter receptacle 90 and/or a filter unit not shown and downstream to a breathing connection receptacle 80. The blower filter device 100 may further comprise a control unit 60 for controlling the blower unit 70 and for processing the inputs and providing display information.

The blower filter device 100 can be connected to a breathing connection interface 310 of the breathing connection 300 via the breathing connection receptacle 80.

The blower filter device 100 may further comprise an energy storage unit 40, wherein the energy storage unit 40 is arranged entirely within the housing 10, as shown in both embodiments.

It is possible that the blower filter device 100 can have a plurality of modules, each of which is delimited by a housing element and can thus be assembled to form the blower filter device 100. For this purpose, the blower filter device 100 can have a first housing element 10a and a second housing element 10b as shown, which can be connected to each other mechanically and optionally also in terms of data and/or energy via a housing interface 13.

In the embodiment according to FIG. 2, the energy storage unit 40 can be arranged in a first module of the blower filter device 100, which can be delimited by the first housing element 10a.

In the embodiment according to FIG. 3, the energy storage unit 40 can be arranged in a second module of the blower filter device 100, which can be delimited by the second housing element 10b.

The blower filter device 100 can have an energy interface 41 for charging the energy storage unit 40, whereby the energy interface 41 in this case is arranged completely within the housing 10 or completely within one of the housing elements 10a, 10b.

In the embodiment according to FIG. 2, the energy interface 41 can be arranged in the first module of the blower filter device 100, which can be delimited by the first housing element 10a.

In the embodiment according to FIG. 3, the energy interface 41 can be arranged in the second module of the blower filter device 100, which can be delimited by the second housing element 10b.

The blower filter device 100 may include a mechanical interface 50 for connection to a carrying structure 200 for carrying the blower filter device 100 by a user B, wherein the mechanical interface 50 is configured as shown as an interface extending away from the housing 10.

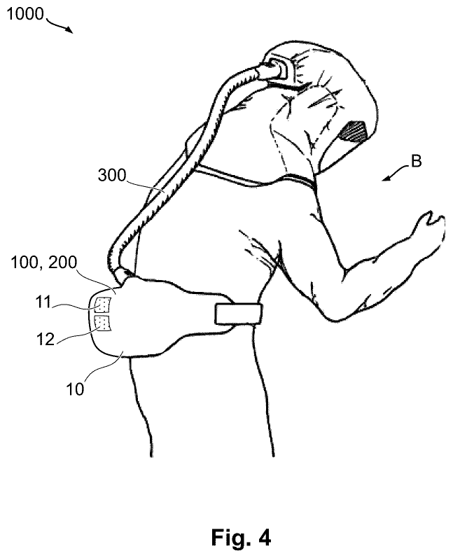

FIG. 4 shows an embodiment of a blower filter system 1000 and blower filter device 100 according to the invention, in which the blower filter device 100 is fully integrated into the carrying structure 200. This blower filter device 100 has a translucent area 11 that is visible from the outside and an input area 12 that can be operated from the outside.

While specific embodiments of the invention have been shown and described in detail to illustrate the application of the principles of the invention, it will be understood that the invention may be embodied otherwise without departing from such principles.

### LIST OF REFERENCE CHARACTERS

10 Housing (case)
10 First housing element
10 Second housing element
11 Translucent area
12 Input area
13 Housing (casing) interface
20 Display element
21 Rays (schematically shown)
30 Control element
40 Energy storage unit
41 Energy interface
50 Mechanical interface
60 Control unit
70 Blower unit
71 Line
80 Breathing connection receptacle
90 Filter interface
100 Fan filter unit
200 Carrying structure
300 Breathing connection
310 Breathing connection interface
1000 Blower filter system
B User

What is claimed is:

1. A blower filter device comprising a housing, wherein at least one display element and/or at least one control element is integrated into the housing without an opening.

2. A blower filter device according to claim 1, wherein the at least one control element is arranged and configured to be operated by voice input and/or touch input and/or gesture input.

3. A blower filter device according to claim 1, wherein the housing comprises a translucent area, and wherein the at least one display element is arranged to shine through the translucent area to effect a display.

4. A blower filter device according to claim 1, further comprising an energy storage unit, wherein the energy storage unit is arranged completely within the housing.

5. A blower filter device according to claim 4, further comprising an energy interface for charging the energy storage unit, wherein the energy interface is arranged completely within the housing.

6. A blower filter device according to claim 1, further comprising a mechanical interface configured to connect to a carrying structure for carrying the blower filter device by a user, wherein the mechanical interface is configured as an interface extending away from the housing.

7. A blower filter system comprising:
a blower filter device comprising a housing, wherein at least one display element and/or at least one control element is integrated into the housing without an opening; and
a carrying structure configured to carry the blower filter device by a user, wherein the blower filter device is fully integrated into the carrying structure.

8. A blower filter system according to claim 7, wherein the at least one control element is arranged and configured to be operated by voice input and/or touch input and/or gesture input.

9. A blower filter system according to claim 7, wherein the housing comprises a translucent area, and wherein the at least one display element is arranged to shine through the translucent area to effect a display.

10. A blower filter system according to claim 7, further comprising an energy storage unit, wherein the energy storage unit is arranged completely within the housing.

11. A blower filter system according to claim 10, further comprising an energy interface for charging the energy storage unit, wherein the energy interface is arranged completely within the housing.

12. A blower filter system according to claim 7, further comprising a mechanical interface configured to connect to a carrying structure for carrying the blower filter device by a user, wherein the mechanical interface is configured as an interface extending away from the housing.

13. A blower filter device comprising:
a housing with a breathing connection receptacle configured to connect to a breathing connection interface and a filter interface configured to receive a filter unit; and
at least one display element and/or at least one control element, wherein the housing has a display element and/or control element surface area in front of or behind the at least one display element and/or the at least one control element and the display element and/or control element surface area is gap free with no opening in the display element and/or control element surface area.

14. A blower filter device according to claim 13, wherein an entire surface of the housing, apart from the breathing connection receptacle and the filter interface, is gap free with no opening.

15. A blower filter device according to claim 13, wherein the at least one display element and/or at least one control element is integrated into the housing without an opening in the housing.

16. A blower filter device according to claim 13, wherein the at least one control element is arranged and configured to be operated by voice input and/or touch input and/or gesture input.

17. A blower filter device according to claim 13, wherein the housing comprises a translucent area in the display element and/or control element surface area, and wherein the at least one display element is arranged to shine through the translucent area to effect a display.

18. A blower filter device according to claim 13, further comprising an energy storage unit, wherein the energy storage unit is arranged completely within the housing.

19. A blower filter device according to claim 18, further comprising an energy interface for charging the energy storage unit, wherein the energy interface is arranged completely within the housing.

20. A blower filter device according to claim 13, further comprising a mechanical interface configured to connect to a carrying structure for carrying the blower filter device by a user, wherein the mechanical interface is configured as an interface extending away from the housing.
